(19) United States
(12) Patent Application Publication
(10) Pub. No.: US 2007/0129190 A1
(43) Pub. Date: Jun. 7, 2007

(54) DRIVE CHAIN INSPECTION COVER PLATE AND FILL PLUG FOR MOTORCYCLES

(76) Inventor: Monteville L. Sloan JR., Wagener, SC (US)

Correspondence Address: MAINE & ASMUS, 100 MAIN STREET, P O BOX 3445, NASHUA, NH, 03061-3445, US

(21) Appl. No.: 11/549,133

(22) Filed: Oct. 13, 2006

Related U.S. Application Data
(60) Provisional application No. 60/726,961, filed on Oct. 14, 2005.

(51) Int. Cl. B62J 13/00; F16H 57/02; F16D 1/00

(52) U.S. Cl. 474/144

(57) ABSTRACT

A side access fill spout and plug for a fluid container, such as for a drive chain housing for motorcycles, has a filler plug with an upper O-ring seated in the top section and exposed axially downward, and a lower O-ring seated on its shaft exposed radially. The cover plate has a fill spout projecting out and up, with a straight line bore and an O-ring locking groove in the wall of the bore spaced from the top edge of the spout so that the upper O-ring is held in compression against the top edge of the spout by the lower O-ring when expanded into the locking groove, holding the plug securely in place. The bore reduces in diameter below the locking groove to provide additional material to the underside of the junction of the spout and the cover plate.

This application relates and claims priority to pending U.S. application Ser. No. 60/726,961, filed Oct. 14, 2005.

### FIELD OF THE INVENTION

The invention relates to inspection cover plates and fill plugs for motorcycles and other low or non-pressurized gearbox or chain drive enclosures requiring side panel access for checking fluid levels and adding materials.

### BACKGROUND OF THE INVENTION

In some motorcycle drive systems, the engine crankshaft is connected to a manually operated clutch via a chain drive. The drive chain is trained around a drive sprocket on one end of the crankshaft and a driven sprocket carried by the clutch. The chain and sprocket assembly is located within primary drive housing at the lower end of the engine. The lower line of the chain is typically immerged in an oil bath contained within the housing, for lubrication. The housing has a main cover enclosing the outboard side of the chain and sprocket assembly. The main cover generally has an access opening that is normally covered by an inspection cover or plate, which is secured with a gasket to the main cover by several screws or similar fasteners to prevent leakage of the oil.

The oil level must be maintained, and the oil changed periodically, in order to avoid damage to the chain and sprocket assembly. In most cases the original equipment design requires that the inspection cover or plate be removed when adding new primary oil. Upon completion of the primary oil change this inspection cover or plate is then secured with a new gasket to the main cover by the same several screws or fasteners to prevent leakage of the oil.

It is known in the art to incorporate a filler plug in the cover plate, both as original equipment and as an after-market accessory to the motorcycle. After-market accessories such as an improved inspection cover and fill plug assembly are highly desirable in some market segments as either or both a functional or esthetic improvement to the original equipment cover plate.

Motorcycle engines and enclosed drive systems are not alone in needing a conveniently accessible port on an exposed side of the machine or device in the form of a robust side cover plate and plug for filling an enclosed but basically non-pressurized case containing moving parts, for inspection, checking the fluid level and adding a lubricating or cooling fluid or other additives or materials to it.

There is a need to address problems such as ease of installation of the inspection cover plate, ease of use of the fill plug feature, leakage of oil or fluid at the edges of the cover and/or the plug seal, strength of design of the cover and fill bore structure, ease of removal and installation of the plug, and integrity of plug seal from infiltration and/or leakage and from loosening during vehicle operations or vibrations from any source.

### SUMMARY OF THE INVENTION

One embodiment of the present invention provides an aftermarket inspection cover accessory for selected motorcycle makes and models, having an inspection cover plate incorporating an outward and upward angled fill spout with a particularized bore detail, and a mating plug, the spout and plug having a particular closure and multiple O-ring sealing mechanism. The inspection cover is configured to fit the standard inspection access opening of the chain and sprocket assembly main housing, using the same or similar size gasket. It is configured with holes matching the threaded mounting holes that are normally provided for screw-type fasteners around the periphery of the access opening in the main housing.

The thickness of the aftermarket cover plate in the area of the holes is limited to the extent that the same fasteners used in the original equipment cover plate and gasket can be used to install the aftermarket cover plate and gasket, although a thicker or thinner cover plate and alternative gaskets and fasteners may be required for other embodiments. Other variations of the invention may include an original equipment main housing or aftermarket main housing incorporating the spout and plug of this or other embodiments of the invention.

The cover plate, spout and plug assembly may be fabricated of and finished with various materials, by various means, including but not limited to such materials as steel, aluminum, other alloys, composites, or plastics, using fabrication means including any of machining, forging, molding, casting, gluing, or welding techniques, and chrome or paint or other surface or full body treatments or surface finishing techniques.

The fill spout has a linear axis and bore that extends upward and outward from a lower opening in the substantially vertical plane of the inside surface of the inspection cover, to the mouth of the spout. The mouth of the spout is planar and oriented normal to the axis of the bore. The axis of the bore is angled outward at about 60 degrees, plus or minus a few degrees from the vertical plane of the exposed side of the housing, and slightly forward of vertical as viewed from the side, although it may be vertical or inclined slightly rearward from this perspective.

The mouth of the bore is sufficiently large for adding fluid to the fluid reservoir within the main housing by pouring or by use of a funnel. The diameter of the bore in this embodiment is about 1¼ inches, but it may be somewhat larger or smaller.

The lower or inner end of the bore terminates at the inner face of the cover plate within the periphery of the gasket. The intersection of the circular spout wall structure and the cover plate is configured with sufficient material around the circumference of the spout wall to assure adequate strength and fitness for the intended use.

A non-vented fill plug is provided for capping the spout by insertion in a sealing manner into the bore. The fill plug has a top end with a larger diameter knurled surface for gripping; a flat underside to the top end section that mates to the flat face or mouth of the spout, a straight shaft section with a tapered lower end terminating in a flat bottom end, sized to fit easily within the bore. There is an upper O-ring seat milled into the flat underside of the top end section, and a lower O-ring seat milled into the straight shaft section, with an O-ring installed in each of the ring seats. It will be noted that the upper O-ring has a downward facing plane of exposure, and the lower O-ring has an outward facing circular area of exposure.

The flat brim or planar face at the mouth of the spout intersects a chamfered or slightly tapered bore entry section leading into a bore section of uniform diameter. The taper eases the insertion of the lower O-ring of the filler plug into the bore. An O-ring gripping groove or recess is let into the sidewall of the bore at a suitable depth from the mouth or face of the bore. This bore wall recess acts as a circular detent in the bore wall for capturing the lower O-ring on the filler plug when it is fully inserted in the spout.

The bore section of a uniform first diameter continues below the detent to a first point of intersection with the inner surface of the cover plate. The bore has a reducing diameter tapered shoulder section that intersects the inner surface of the cover plate. The tapered section may terminate in a uniform smaller diameter section of the bore, as in this embodiment, which intersects the inner surface of the cover plate and completes the definition of the bore opening in the inner surface of the cover plate. The tapered section of the bore roughly corresponds, with clearance, with the tapered shape of the plug end.

One benefit of the tapered bore section beginning at about the first point of intersection of the larger bore diameter with the inner surface of the cover plate is that the acute outward angle of the spout in combination with the tapered bore section assures that there will be more material in the area of the underside of the junction of the spout with the cover plate, not withstanding the use of a fillet of uniform radius being used around the full circumference of the spout at its intersection with the cover plate. As will be readily apparent to those skilled in the art, the top side of this junction of spout and cover plate enjoys an acute angle of intersection where a fillet of the same radius has a larger cross section area of material.

A characteristic of this tapered bore geometry is a bore hole in the cover plate that is an intersection of a non-uniform bore diameter with the inner surface of the cover plate.

When the plug is fully inserted into the spout, the exposed surface of the upper O-ring contacts the mouth of the spout in an axially compressive sealing manner at the same depth that the lower O-ring is engaged in the bore wall detent in both a radially compressive sealing manner, and in an axial shear pressure sealing manner that places the plug slightly in tension and supplies a continuous compressive force on the upper O-ring as between the mouth of the spout and the plug.

The plug is simply pushed in to the filler spout until it is seated as described, forming a dual O-ring seal against oil leakage and a position retention force or feature that assures the plug will remain in position. For removal, the knurled cap of larger diameter provides adequate leverage for manually pulling the plug out of the spout, with a twisting motion if desired to facilitate breaking the seal and compress the lower O-ring sufficiently against the shoulder of the lower O-ring detent to release the plug.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a perspective view of a motorcycle chain drive housing with one embodiment of an inspection cover plate with filler spout and fill plug of the invention installed.

FIG. 2 is a top view of the cover plate and filler spout of one embodiment of the invention, disclosing the upward and forward angle of the fill spout, with the locking O ring groove, tapered shoulder recessed within the bore, and the keyhole exit of the bore through the backside of the cover plate.

FIG. 3 is an axial view into the bore of the cover plate of FIG. 2, further illustrating the shoulder recessed within the bore and the keyhole profile of the bore's lower end opening through the backside of the cover plate.

FIG. 4 is a back side view of one embodiment of a cover plate and fill spout of the invention, illustrating in conjunction with FIG. 5 the intersection of the non-uniform diameter of the bore with the inner surface of the cover plate.

FIG. 5 is a cross section view along the axis of the bore of the cover plate of FIG. 4, illustrating the slight top end taper of the bore for easing in the plug, the O-ring locking groove, and recessed taper within the bore intersecting the backside of the cover plate.

FIG. 6 is a perspective view of the fill cap, illustrating the knurled top, upper O-ring in the underside of the top, the lower O-ring on the shaft, and the tapered lower end that conforms with clearance to the tapered bore in the cover plate.

### DETAILED DESCRIPTION

The description below is illustrative of but not exhaustive of the many embodiments within the scope of the invention.

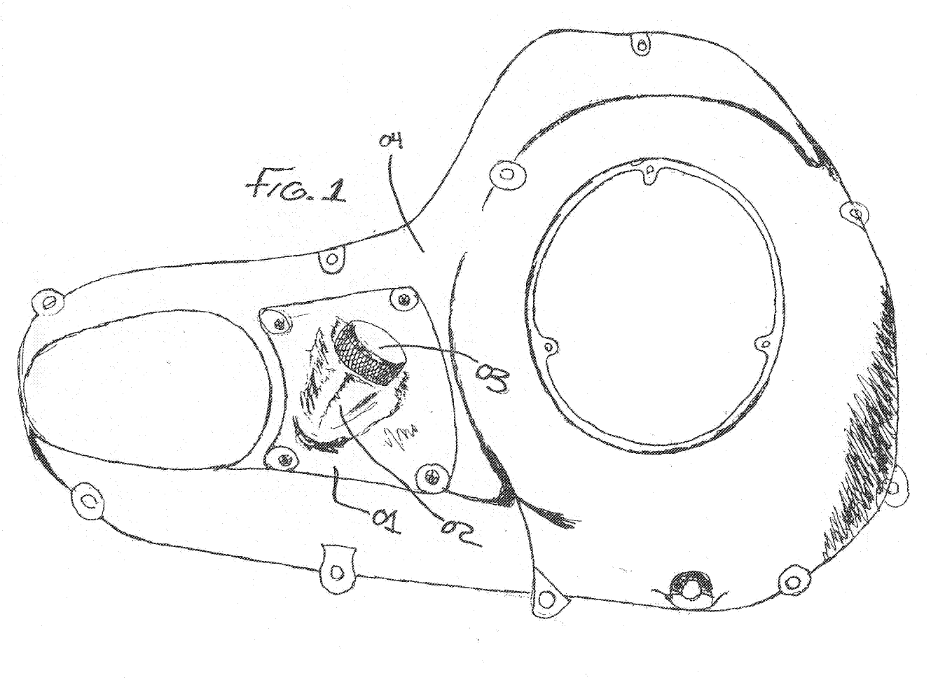

Referring to FIG. 1, a perspective view of one embodiment of the invention, associated with motorcycle chain drive housing 04, includes an inspection cover plate 01 with filler spout 02 and fill plug 03. The orientation of the cover plate to the housing puts it in substantially a vertical plane with the spout directed upwards and forward relative to the motorcycle.

The fill spout 02 and plug 03 permit easy inspection of the oil and oil level, and changing of the oil level within the housing. The cover plate 01 may have many shapes, and may be flat or have a simple or a complex curvature in order to fit the available opening in the housing and provide an ergonomic shape and projection of the fill spout for easy access from the side of the motorcycle. The housing in some embodiments may require modification to accept the desired aftermarket cover plate. In other embodiments, the cover plate may require modification to fit the available opening in the housing. In other embodiments, the original equipment housing or an aftermarket housing may incorporate the spout and plug of this or a similar embodiment.

The method for fastening the cover plate to the housing may be the same as the original cover plate it replaces, such as by using the same gasket and the same fasteners in the same holes; or it may be different, using a different gasket and different fasteners or a different fastening mechanism. The materials of which the cover plate and fill spout may be fabricated are numerous, including metal, metal alloys or plastic or such other materials as are suitable to the temperature, pressure, stress of usage, and environmental requirements. The method of making the rigid components is not limited and may include any or a combination of casting, molding, and/or machining. The manner of materials treatment and surface finish may vary accordingly. O-rings, which are inherent to one aspect of the design, are a well understood technology for their compressive and sealing characteristics, and need no elaborate description or specification here, whether for motorcycles and chain drive enclosures or such other applications and fluids as to which the invention may be readily adapted.

It should be noted for context that an O-ring is a generic term for a elastic device in the form of a circular ring that typically, but not necessarily, also has a circular cross section. Other cross sections such as square or semi-circular or otherwise may be perfectly acceptable, depending on the manner of use. For example, an O-ring of other than fully circular cross section may be used in any or all of several modes: a compression mode under pressure applied in a vertical (normal to the plane of the ring) direction; a compression mode from radially inward forces; or an expansion mode from radially outwardly acting forces from within the ring's diameter. Where an O-ring is subjected to a sliding contact with another surface to reach its intended seat, it is normally preferred but not necessary to have a circular profile or cross section in so far as the exposed surface is concerned. For example, the inner diameter is a sliding surface when an O-ring is being slid over and along a shaft. The outer diameter is a sliding surface when a shaft with an O-ring seated in a retention groove on the shaft is slid through a tubular structure or bore. Depending on the surface condition and available lubrication, a rectangular cross section may perform adequately. And in the case of an axial load, there may be no sliding action required at all. For purposes of this specification and the claims that follow, an O-ring is not limited to a circular cross section.

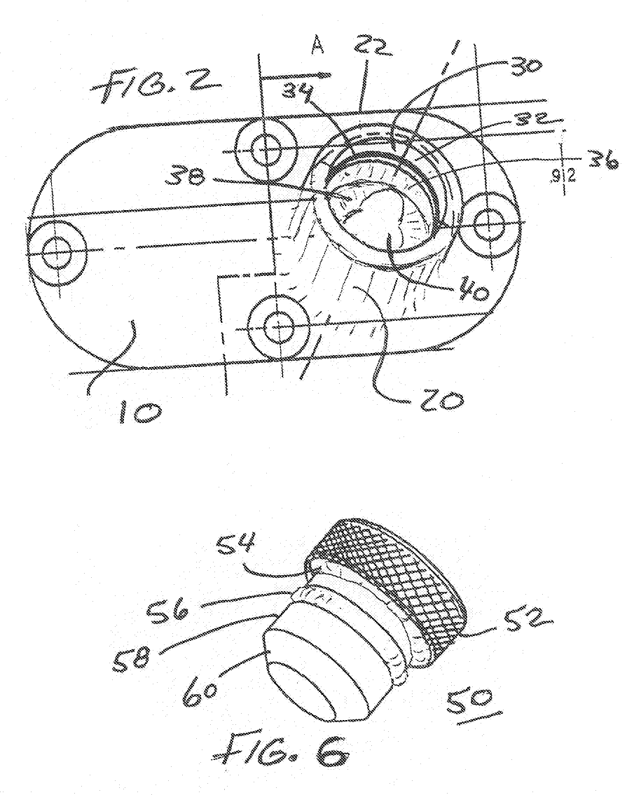

Referring to FIG. 2, a top view of the cover plate 10 and filler spout 20 of one embodiment of the invention discloses the upward and forward angle of the fill spout. The shape of cover plate 10 is somewhat different than cover plate 01 of FIG. 1, but illustrates merely another variation of shape as between the many embodiments.

Referring to FIG. 3, an axial view into the bore 30 of spout 20 and cover plate 10 of FIG. 2 illustrates the shoulder or tapered section 38 within bore 30, and the keyhole exit 40 profile of the bore's lower end opening through the backside of cover plate 10. The spout transitions to the cover plate via fillet 26 of uniform radius.

Referring to FIG. 6, there is shown a perspective view of the fill cap 50, illustrating the knurled top 52, upper O-ring 54 under the edge, flange or skirt of the top, the lower O-ring 56 on shaft 58, and the tapered end 60 that conforms to the tapered bore 30 in spout 20 of cover plate 10.

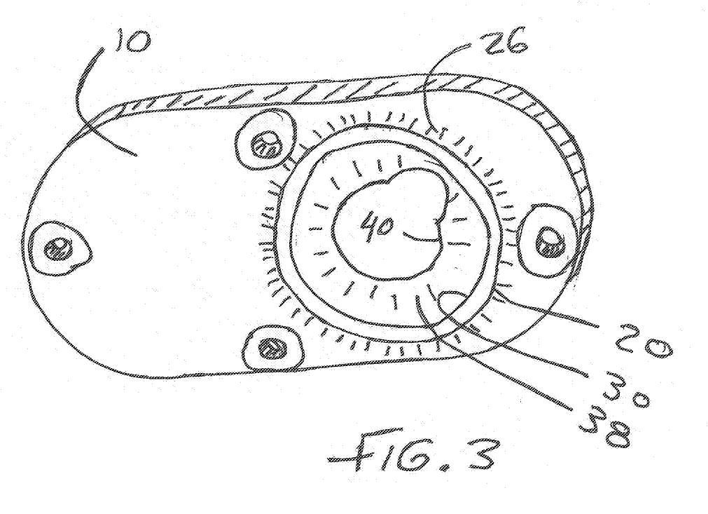

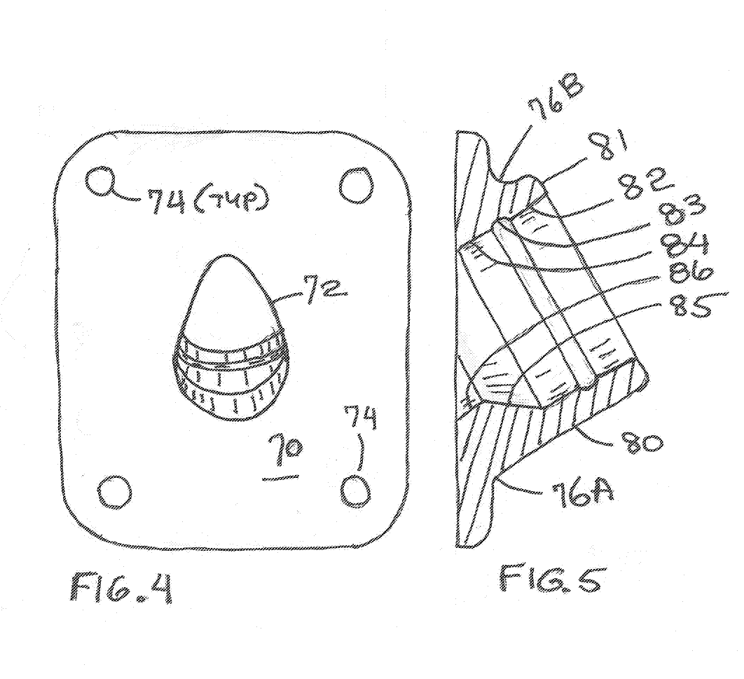

Referring to FIGS. 4 and 5, the back side 70 and a cross section view of another embodiment of a cover plate and fill spout of the invention are illustrated. The profile of exit 72 in backside 70 is clearly defined by the intersection of the non-uniform diameter of the bore of spout 80 with the back side of cover plate, as is further explained below.

Referring to FIGS. 5 and 6, FIG. 5 is a cross section view along the axis of spout 80 of the embodiment of FIG. 4, and illustrates the face 81 of spout 80 that makes sealing contact with the upper O-ring 54 of plug 50. Within the bore of spout 80, the slight top end taper of section 82 for easing in the filler plug 50 of FIG. 6, is evident. Extending down into the bore, section 82 is followed by O-ring locking groove 83, for receiving the lower O-ring 56 of plug 50, followed by uniform larger diameter section 84, then tapered section 85 and smaller diameter straight section 86, which both intersect backside 70 to define bore exit 72.

It will be apparent from FIGS. 4 and 5 that the fillet radius 76 around spout 80 provides more material at the interior angle at the top of the intersection of spout and cover plate at 76B than at the larger, underside angle of intersection at 76A. The recessed shoulder in the bore, tapered section 85, provides additional material near 26A to strengthen the structure in that underside area.

Referring back to FIGS. 2 and 3 for comparison, within the top edge 22 of spout 20, bore 30 extends downward via the top edge tapered section 32, locking O-ring groove 34, large uniform diameter straight section 36, tapered section 38, smaller uniform diameter lower end section 39, penetrating cover plate 10 at the angle of intersection with the non-uniform diameter of the bore and terminating in the notably irregular pattern of exit 40. The union of the spout and the cover plate has a fillet radius 26 around the periphery that adds much more material at the smaller angle of intersection at 26B, about 60 degrees in this embodiment than at the larger exterior angle of underside intersection at 26A, of about 120 degrees. It will be apparent from the figures that the uniform outer diameter of spout 20 and its decreasing bore diameter occurring in the region of the intersection of the spout and the cover plate, adds material to the junction on the long wall or underside junction of the spout and the cover plate.

Referring again to FIG. 6, the spacing of upper O-ring 54 and lower O-ring 56 is such as to place the fill cap 50 in suspension within spout 20 (or spout 80) and in tension as to the compression of O-ring 54 on top edge 22 (or 81) and in shear pressure on O-ring 56 when engaged in O-ring locking groove 34 (or 83). There is no other point of contact between the installed fill cap 50, and the spout or its bore other than the two O-ring seals at their respective seats.

Other and numerous embodiments are within the scope of the invention. For example, there may be an extended spout and bore with additional O-ring locking grooves, and mating plugs with longer shafts and multiple lower O-rings suitable spaced to match the locking grooves. There may be a rotationally capable threaded cap on the plug, and external threads on the spout, that permit the plug to be secured and removed by rotation of the cap. This or a conductive chain or cable connecting the plug to the spout or housing may provide an electrical ground connection where appropriate. The reduction in diameter of the bore in the region of angular intersection with the cover plate may be smoothly transitional rather than sharply defined as illustrated, so long as the effect of adding material in the underside area of the spout and cover plate junction is achieved.

As another example, referring again to the figures, there may be a drive chain inspection cover plate, fill spout and fill plug assembly for motorcycles that includes a cover plate configured with a fill spout and adapted to fit an inspection port in a drive chain housing so as to be oriented in a substantially vertical plane with the fill spout projecting outward and upward from the cover plate. The spout may have a mouth and a bore though which fluids may be passed, with the bore extending through the cover plate at an angle other than normal and terminating in an exit hole on the backside of the cover plate. The bore has a first region of relatively larger diameter proximate the mouth of the spout and a second region of relatively reduced diameter proximate the exit hole. The bore has an O-ring locking groove recessed in the wall of the bore in the first region.

There is a fill plug with a top section and a shaft section, where the top section has a larger diameter than the shaft section and is configured with an upper O-ring exposed axially downward from an O-ring retention groove in the underside of the top section for making sealing contact with the mouth of the fill spout, and a lower O-ring exposed radially from an O-ring retention groove on the shaft section for making locking and sealing contact with the locking groove in the wall of the bore. The O-ring locking groove is spaced from the mouth of the spout such that the upper O-ring is held in compression against the mouth of the spout by retention of lower O-ring in axial tension in the locking groove when the plug is fully inserted into the spout. The first region of the bore may have a slightly flared or tapered entrance to a uniform diameter, to ease installing the fill plug and its lower O-ring. The second region of the bore may have a conical section and a terminal section of relatively smaller uniform diameter than the first region, where as illustrated in the figures, the conical section connects the first region to the terminal section. The profile of the exit hole may be defined by the intersection of the conical section and/or the terminal section, and the backside of said cover plate.

The shaft section of the fill plug may terminate as in FIG. 6, with a matching conical section and flat end where the length of the plug shaft and cone angle are sized for clearance within the bore when the fill plug is fully seated in the spout. And the fill plug when installed in the bore may be fully supported by the O-rings with no other contact between the plug and the mouth and bore. There may be a gasket suitable for sealing the cover plate over an opening in a drive chain housing. The fill spout may be inclined outward and upward at between about 30 and 60 degrees from vertically up.

As still another example of the further scope of application of the invention, there is a side access fill spout and fill plug assembly for access to a fluid container, consisting of a substantially vertically oriented wall component of a fluid container configured with a fill spout projecting outward and upward from said wall component, where the spout and plug have the same characteristics described above and illustrated in the figures. The container may be a housing for mechanical parts partially submerged in a fluid bath, such as a motor housing or a drive train housing or other enclosure of moving mechanical parts operating partially submerged in a fluid lubricant or coolant. The container may be any enclosure partially filled with fluid, for which direct and easy access is required for checking the level and condition of the fluid and adding or removing fluid if needed. The fill plug may be flexibly electrically coupled to the wall component as by a wire or grounding strap, snap or cap or other permanent or manually actuated connecting means in applications where the electrical isolation provided to the fill plug by the O-rings may be a disadvantage.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A drive chain inspection cover plate, fill spout and fill plug assembly for motorcycles comprising;
a cover plate configured with a fill spout and adapted to fit an inspection port in a drive chain housing so as to be oriented in a substantially vertical plane with said fill spout projecting outward and upward from said cover plate, said spout having a mouth and a bore though which fluids may be passed, said bore extending through said cover plate at an angle other than normal and terminating in an exit hole on the backside of said cover plate, said bore having a first region of relatively larger diameter proximate said mouth and a second region of relatively reduced diameter proximate said exit hole, said bore having an O-ring locking groove recessed in the wall of the bore in said first region; and
a fill plug with a top section and a shaft section, said top section configured with an upper O-ring exposed axially downward from an O-ring retention groove in the underside thereof for making sealing contact with the mouth of said fill spout and a lower O-ring exposed radially from an O-ring retention groove in said shaft section for making locking and sealing contact with said locking groove in the wall of said bore, said O-ring locking groove spaced from the mouth of said spout such that said upper O-ring of said plug is held in compression against said mouth by retention of said lower O-ring in said locking groove when said plug is fully inserted into said spout.

2. The drive chain inspection cover plate, fill spout and fill plug assembly of claim 1, said first region of said bore comprising a slightly flared entrance to a uniform diameter.

3. The drive chain inspection cover plate, fill spout and fill plug assembly of claim 1, said second region of said bore comprising a conical section and a terminal section of relatively smaller uniform diameter than said first region, wherein said conical section connects said first region to said terminal section.

4. The drive chain inspection cover plate, fill spout and fill plug assembly of claim 3, the profile of said exit hole comprising the intersection of said conical section and said backside of said cover plate.

5. The drive chain inspection cover plate, fill spout and fill plug assembly of claim 3, the profile of said exit hole comprising the intersection of said terminal section and said backside of said cover plate.

6. The drive chain inspection cover plate, fill spout and fill plug assembly of claim 3, said shaft section of said fill plug terminating in a matching conical section and flat end wherein the length of the plug shaft and cone angle are sized for clearance within said bore when said fill plug is fully seated therein.

7. The drive chain inspection cover plate, fill spout and fill plug assembly of claim 3, said fill plug when installed in said bore being fully supported by said O-rings with no other contact with said mouth and bore.

8. The drive chain inspection cover plate, fill spout and fill plug assembly of claim 1, said cover plate configured with mounting holes about its periphery.

9. The drive chain inspection cover plate, fill spout and fill plug assembly of claim 1, further comprising a gasket suitable for sealing said cover plate over an opening in a drive chain housing.

10. The drive chain inspection cover plate, fill spout and fill plug assembly of claim 1, said fill spout being inclined outward and upward at between about 30 and 60 degrees from vertical.

11. The drive chain inspection cover plate, fill spout and fill plug assembly of claim 1, said bore having a straight line axis from said mouth to said exit hole.

12. A side access fill spout and fill plug assembly for access to a fluid container comprising;
a substantially vertically oriented wall component of a said fluid container configured with a fill spout projecting outward and upward from said wall component, said spout having a mouth and a straight bore though which fluids may be passed, said bore extending through said wall component at an angle at least about 30 degrees upward from normal and terminating in an exit hole on the backside of said wall component, said bore having a first region of relatively larger diameter proximate said mouth and a second region of relatively reduced diameter proximate said exit hole, said bore having an O-ring locking groove recessed in the wall of the bore in said first region; and
a fill plug with a top section and a shaft section, said top section configured with an upper O-ring exposed axially downward from an O-ring retention groove in the underside thereof for making sealing contact with the mouth of said fill spout and a lower O-ring exposed radially from an O-ring retention groove in said shaft section for making locking and sealing contact with said locking groove in the wall of said bore, said O-ring locking groove spaced from said top section such that said upper O-ring of said plug is held in compression against said mouth of said spout by retention of said lower O-ring in said locking groove when said plug is fully inserted into said spout.

13. The side access fill spout and fill plug assembly of claim 12, said fluid container comprising a housing for mechanical parts partially submerged in a fluid bath.

14. The side access fill spout and fill plug assembly of claim 12, said fill plug when installed in said bore being fully supported by said O-rings with no other contact with said mouth and bore.

15. An inspection cover plate, fill spout and fill plug assembly for the chain drive housing of a motorcycle comprising;
a cover plate configured with a fill spout and mounting holes about its periphery, adapted to fit an inspection port in said housing so as to be oriented in a substantially vertical plane with said fill spout projecting outward and upward from said cover plate at an angle of about 60 degrees from vertically upward, said spout having a mouth and a straight bore though which fluids may be passed, said bore piercing said cover plate and terminating in an exit hole on the backside of said cover plate, said bore having a first region of relatively larger diameter proximate said mouth and a second region of relatively reduced diameter proximate said exit hole, said second region comprising a conical section and a terminal section of relatively smaller uniform diameter than said first region wherein said conical section connects said first region to said terminal section, the profile of said exit hole comprising the intersection of said second region with the backside of said cover plate, said bore having an O-ring locking groove recessed in the wall of the bore in said first region; and
a fill plug with a top section and a shaft section, said top section configured with an upper O-ring exposed axially downward from an O-ring retention groove in the underside thereof for making sealing contact with the mouth of said fill spout and a lower O-ring exposed radially from an O-ring retention groove in said shaft section for making locking and sealing contact with said locking groove in the wall of said bore, said O-ring locking groove spaced from said top section such that said upper O-ring of said plug is held in compression against said mouth of said spout by retention of said lower O-ring in said locking groove when said plug is fully inserted into said spout.

16. An inspection cover plate, fill spout and fill plug assembly according to claim 15, further comprising a gasket suitable for sealing said cover plate over an opening in said housing.

17. A side access fill spout and fill plug assembly according to claim 12, said assembly configured with a coupling means for electrically grounding said fill plug to said wall component.
